(19) United States
(12) Patent Application Publication
(10) Pub. No.: US 2025/0240496 A1
(43) Pub. Date: Jul. 24, 2025

(54) DISPLAY APPARATUS AND DISPLAY METHOD

(71) Applicant: Samsung Electronics Co., Ltd., Suwon-si (KR)

(72) Inventors: Jaeyoung LEE, Suwon-si (KR); Seungjoon LEE, Suwon-si (KR); Donghee KANG, Suwon-si (KR)

(21) Appl. No.: 19/175,705

(22) Filed: Apr. 10, 2025

Related U.S. Application Data
(63) Continuation of application No. PCT/KR2023/012176, filed on Aug. 17, 2023.

(30) Foreign Application Priority Data
Oct. 11, 2022 (KR) 10-2022-0129730

(51) Int. Cl. H04N 21/488; G06F 40/58; H04N 21/439

(52) U.S. Cl. CPC H04N 21/4884; G06F 40/58; H04N 21/439

(57) ABSTRACT

A display apparatus may include: a display; a communication apparatus that receives stream data corresponding to image content in real time; a memory for storing the received stream data; and a processor that generates an image frame by decoding stream data corresponding to an Nth frame among the stored stream data, and controls the display so as to display the generated image frame, wherein the processor extracts, before generating the image frame by decoding the stream data corresponding to the Nth frame, audio data from stream data corresponding to a preconfigured time interval before the Nth frame among the stored stream data, generates a subtitle frame by using the extracted audio data, and controls the display to display the subtitle frame and image frame corresponding to the Nth frame together.

### CROSS-REFERENCE TO RELATED APPLICATIONS

This application is a continuation application of International Application No. PCT/KR2023/012176 designating the United States, filed on Aug. 17, 2023, in the Korean Intellectual Property Receiving Office and claiming priority to Korean Patent Application No. 10-2022-0129730, filed on Oct. 11, 2022, the disclosures of which are all hereby incorporated by reference herein in their entireties.

### BACKGROUND

### Technical Field

Certain example embodiments may relate to a display apparatus and/or a display method, and for example to a display apparatus that can display by using audio data to generate caption information for content that need not include caption data, and/or a display method.

### Background Art

Display apparatuses may be apparatuses that display image signals received from the outside. Recently, broadcast companies are making it easy for even a hearing-impaired person to view content by transmitting broadcast images that include caption data.

However, a percentage of caption data being provided in terrestrial broadcasting is quite low, and in light of the percentage of caption data being provided for not only terrestrial broadcasting, but also streaming content, being low, there is a limit to the content which a hearing-impaired person can use.

### SUMMARY

According to an example embodiment, a display apparatus may include a display, a communication device, comprising communication circuitry, which receives stream data corresponding to image content in real-time, a memory which stores the received stream data, and a processor, comprising processing circuitry, configured to generate an image frame by decoding stream data corresponding to an Nth frame from among the stored stream data, and control the display for the generated image frame to be displayed.

In this case, the processor may be configured to extract, before generating the image frame by decoding stream data corresponding to the Nth frame, audio data from stream data corresponding to a predetermined time interval before the Nth frame from among the stored stream data, generate a caption frame by using the extracted audio data, and control the display to display a caption frame corresponding to the Nth frame and the image frame together.

Further, according to an example embodiment, a display method in a display apparatus may include receiving and storing stream data corresponding to image content in real-time, extracting, before generating an image frame by decoding stream data corresponding to an Nth frame, audio data from stream data corresponding to a predetermined time interval before the Nth frame from among the stored stream data, generating a caption frame using the extracted audio data, generating an image frame by decoding stream data corresponding to the Nth frame from among the stored stream data, and displaying a caption frame corresponding to the Nth frame and the image frame together.

Further, according to an example embodiment, a computer-readable recording medium comprising a program for executing a display method may include receiving and storing stream data corresponding to image content in real-time, extracting, before generating an image frame by decoding stream data corresponding to an Nth frame, audio data from stream data corresponding to a predetermined time interval before the Nth frame from among the stored stream data, generating a caption frame using the extracted audio data, generating an image frame by decoding stream data corresponding to the Nth frame from among the stored stream data, and generating an output image by overlaying a caption frame corresponding to the Nth frame on an image frame corresponding to the Nth frame.

### BRIEF DESCRIPTION OF DRAWINGS

Example embodiments of the disclosure described above or other aspects, features, and advantages will be made clearer through descriptions described below with reference to the accompanied drawings. In the accompanied drawings:

FIG. 1 is a diagram illustrating a display apparatus according to an example embodiment;

FIG. 2 is a diagram illustrating a configuration of an electronic apparatus according to an example embodiment;

FIG. 3 is a diagram illustrating a configuration of a processor according to an example embodiment;

FIG. 4 is a diagram illustrating an operation of a voice data generating unit in FIG. 3;

FIG. 5 is a diagram illustrating an operation of a voice data caption converting unit in FIG. 3;

FIG. 6 is a diagram illustrating an operation of a caption data storing unit in FIG. 3;

FIG. 7 is a diagram illustrating an operation of a caption synchronization module in FIG. 3;

FIG. 8 is a diagram illustrating an operation of a sync module in FIG. 7;

FIG. 9 is a diagram illustrating an example of displaying a caption displayed in an example display apparatus; and

FIG. 10 is a flowchart illustrating a display method according to an example embodiment.

### DETAILED DESCRIPTION

The disclosure will be described in detail below with reference to the accompanying drawings.

Terms used in the disclosure will be briefly described, and the disclosure will be described in detail.

The terms used in the embodiments of the disclosure are general terms selected that are currently widely used considering their function herein. However, the terms may change depending on intention, legal or technical interpretation, emergence of new technologies, and the like of those skilled in the related art. Further, in certain cases, there may be terms arbitrarily selected, and in this case, the meaning of the term will be disclosed in greater detail in the corresponding description. Accordingly, the terms used herein are not to be understood simply as its designation but based on the meaning of the term and the overall context of the disclosure.

Various modifications may be made to the embodiments of the disclosure, and there may be various types of embodiments. Accordingly, specific embodiments will be illustrated in drawings, and the embodiments will be described in detail in the detailed description. However, it should be noted that the various embodiments are not for limiting the scope of the disclosure to a specific embodiment, but they should be interpreted to include all modifications, equivalents or alternatives of the embodiments included in the ideas and the technical scope disclosed herein. In case it is determined that in describing the embodiments, detailed description of related known technologies may unnecessarily confuse the gist of the disclosure, the detailed description thereof will be omitted.

A singular expression includes a plural expression, unless otherwise specified. It is to be understood that the terms such as “configured” or “include” are used herein to designate a presence of a characteristic, number, step, operation, element, component, or a combination thereof, and not to preclude a presence or a possibility of adding one or more of other characteristics, numbers, steps, operations, elements, components or a combination thereof.

The expression at least one of A and/or B is to be understood as indicating any one of “A” or “B” or “A and B”.

Expressions such as “1st”, “2nd”, “first” or “second” used in the disclosure may limit various elements regardless of order and/or importance, and may be used merely to distinguish one element from another element and not limit the relevant element.

When a certain element (e.g., a first element) is indicated as being “(operatively or communicatively) coupled with/to” or “connected to” another element (e.g., a second element), it may be understood as the certain element being directly coupled with/to the another element or as being coupled through other element (e.g., a third element).

The term “module” or “unit” used herein perform at least one function or operation, and may be implemented with a hardware or software, or implemented with a combination of hardware and software. In addition, a plurality of “modules” or a plurality of “units,” except for a “module” or a “unit” which needs to be implemented with a specific hardware, may be integrated in at least one module and implemented as at least one processor (not shown). In the disclosure, the term “user” may refer to a person using an electronic apparatus or a device (e.g., artificial intelligence electronic apparatus) using the electronic apparatus. Thus, each “module” herein may comprise circuitry.

Embodiments of the disclosure will be described in detail below with reference to the accompanying drawings to aid in the understanding of a person of ordinary skill in the art. However, the disclosure may be implemented in various different forms and it should be noted that the disclosure is not limited to the embodiments described herein. Further, in the drawings, portions not relevant to the description may be omitted to clearly describe the disclosure, and like reference numerals may be used to indicate like elements throughout the whole of the disclosure.

An example embodiment will be described in greater detail below with reference to the accompanied drawings.

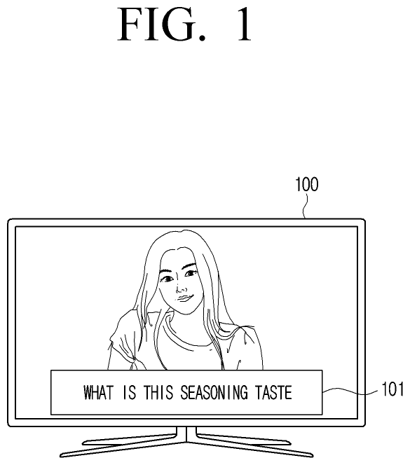

FIG. 1 is a diagram illustrating a display apparatus according to an example embodiment.

Referring to FIG. 1, a display apparatus 100 may receive image content, and display an image corresponding to the received image content. The display apparatus 100 described above may be various devices having a display such as, for example, and without limitation, a television (TV), a monitor, a smartphone, a tablet personal computer (PC), a notebook, and the like. Further, the image content may be content including image data and audio data such as, for example, and without limitation, a video, a video game live streaming, and the like.

Further, the display apparatus 100 may provide a caption service, and display a caption 101 corresponding to an image if a user selected the caption service. The caption service may be a service that displays an utterance context included in audio data in text on a screen of an image.

As described, even with a display apparatus that can provide the caption service, the caption service could not be provided unless a content provider provided caption data together with image data in the related art.

In paricular, in light of there being much more content that does not provide caption data than content that provides caption data, a method for raising availability of the caption service has been in demand. To this end, in the disclosure, voice recognition technology is used for voice recognition of the audio signal, and a result of voice recognition is used as caption data. Here, the voice recognition technology may be technology that converts an acoustic speech signal to a word or a sentence.

As described above, even if a caption service is provided by securing caption data using the voice recognition technology, a proper caption service may not be provided if the caption and the image are not in sync.

For example, if the above-described method is simply employed to an image processing method of the related art, the caption and the image may not be in sync due to a time delay necessary in generating the caption data. Specifically, an audio signal may be necessary for voice recognition, and the audio signal may be obtained by decoding a received broadcast signal (or streaming signal). Further, in light of a processing time being necessary in order to generate caption information by performing voice recognition of the audio signal, a problem of a current image and a caption to be displayed not being in sync may occur

To solve this problem, the processing time necessary for generating the caption information may be shortened, or a method of delaying the display of an image by the above-described processing time may be considered. However, in order to shorten the processing time for generating caption information, a processor having processing performance of high-performance is required, and in order to output by delaying the generated image, an increase in memory capacity by the delayed time is required. Specifically, recently, in light of high-resolution images such as 4K requiring much memory storage space, a solution method using the above-described method has a problem of raising manufacturing cost of a display apparatus.

Accordingly, a method with which the sync between the image and caption can be matched without increasing the manufacturing cost of the display apparatus will be described below.

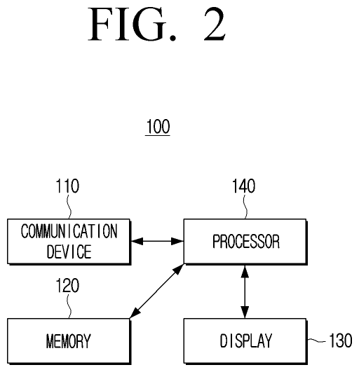

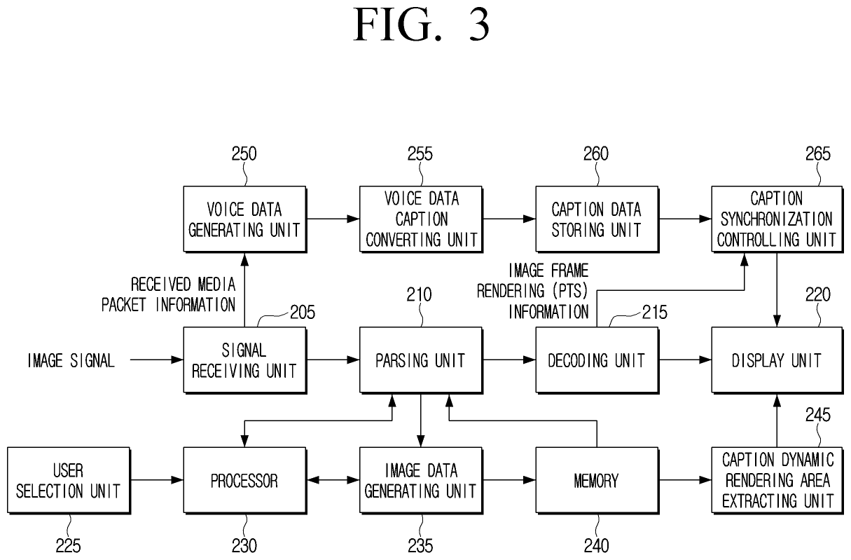

Although audio data is necessary for voice recognition, when using the image and a voice by decoding at a same time-point like a typical content processing method, a delay as described above may be inevitably generated. Accordingly, in the disclosure, decoding of the audio data may be performed at a time-point faster than a decoding time-point of the image data in order to obtain audio data faster than before. As described above, by proactively performing voice decoding than an image decoding time-point corresponding to a specific frame, time necessary in generating caption information may be secured. A more detailed operation will be described with reference to FIG. 2 and FIG. 3.

As described above, by proactively performing the voice decoding than the image decoding, the time necessary in generating the caption data may be secured. Accordingly, because caption data corresponding to a relevant image is secured at a time-point for displaying the image, it may be possible to display by matching the sync of the caption and the image.

The display apparatus 100 according to the disclosure as described above may display by generating caption data on its own even when image content which does not include caption data is provided from the content provider. In addition, because time necessary in generating a caption is secured by proactively performing voice decoding than the decoding time-point of the image, it may be possible to display by accurately matching the sync of the caption and the image.

Meanwhile, in showing and describing FIG. 1, it has been described as being applied to the display apparatus having a display, but the above-described operation may be applied to even electronic device that do not have displays. That is, the above-described operation may be applied to even devices that provide to the display apparatus by receiving image content from the outside such as a set top box and an over the top (OTT) player. The above-described example will be described below with reference to FIG. 3.

Meanwhile, in showing and describing FIG. 1, the above-described operation has been described as being performed when image content is provided through a streaming method. However, the above-described method may be applied to not only when the image content is provided through the streaming method, but also when the downloaded image content is played back.

FIG. 2 is a diagram illustrating a configuration of a display apparatus according to an example embodiment.

Referring to FIG. 2, the display apparatus 100 may be configured with a communication device 110, a memory 120, a display 130, and a processor 140.

The communication device 110 may include circuitry, and transmit and receive information with an external device. The communication device 110 described above may include, for example, and without limitation, a broadcast receiving module (or broadcast receiving device, not shown), a Wi-Fi module (not shown), a Bluetooth module (not shown), a local area network (LAN) module, a wireless communication module (not shown), and the like. Here, each communication module may be implemented in at least one hardware chip form. The communication device 110 described above may be referred to as a transceiver.

The wireless communication module may include at least one communication chip that performs communication according to various wireless communication standards such as, for example, and without limitation, ZigBee, Ethernet, a universal serial bus (USB), a Mobile Industry Processor Interface Camera Serial Interface (MIPI CSI), 3rd Generation (3G), 3rd Generation Partnership Project (3GPP), Long Term Evolution (LTE), LTE Advanced (LTE-A), 4th Generation (4G), 5th Generation (5G), and the like in addition to the above-described communication methods. However, the above is merely one embodiment, and the communication device 110 may use at least one communication module from among various communication modules.

The communication device 110 may receive image content. Here, the image content may be an image content including audio data such as a video or a game streaming content. Further, the image content described above may be received in a form of stream data that is provided in real-time.

The memory 120 may be an element for storing an operating system (O/S) for operating the display apparatus 100 or for storing various software, data, and the like. The memory 120 may be implemented in various forms such as, for example, and without limitation, a random access memory (RAM) or a read only memory (ROM), a flash memory, HDD, an external memory, a memory card, or the like, but is not limited to any one.

The memory 120 may store at least one instruction. The instruction may be an application for voice recognition, an application for controlling the display apparatus 100, an application for providing the caption service, an application for providing a service corresponding to a specific OTT, and the like.

The memory 120 may store the received image content. Specifically, if the image content is received through the streaming method, the memory 120 may sequentially store the received data in packet units. Then, the memory 120 may store various data, parsed data, text information, caption information, and the like generated in a processing process which will be described below. Further, the memory 120 may be implemented in a plurality of configurations rather than one configuration. For example, the above may be implemented in the plurality of configurations such as a first memory which stores the above-described software, and the like, and a second memory which stores image content and the like.

The display 130 may display an image. The display 130 described above may be implemented in displays of various forms such as, for example, and without limitation, a liquid crystal display (LCD), a plasma display panel (PDP), organic light emitting diodes (OLED), quantum dot light-emitting diodes (QLED), and the like. If configured as an LCD, in the display 130, a driving circuit, which may be implemented in a form of an a-si TFT, a low temperature poly silicon (LTPS) TFT, an organic TFT (OTFT), or the like, a backlight unit, and the like may be included. Meanwhile, the display 130 may be implemented as a touch screen coupled with a touch sensor unit.

If configured as an LCD, the display 130 may include a backlight. Here, the backlight may be point light sources configured with a plurality of light sources, and may support local dimming.

Here, the light source that forms the backlight may be configured with a Cold Cathode Fluorescent Lamp (CCFL) or a light emitting diode (LED). The backlight has been shown and described as being formed with light emitting diodes and light emitting diode driving circuit below, but at implementation, the above may be implemented as another configuration other than the LED.

The processor 140 may control an overall operation of the display apparatus 100. For example, the processor 140 may control the overall operation of the display apparatus 100 by executing at least one instruction that is pre-stored.

The processor 140 as described above may be configured as a single device such as a central processing unit (CPU), a micro controller unit (MCU), a micro processing unit (MPU), a controller, a System on Chip (SoC), a large scale integration (LSI), an application-specific integrated circuit (ASIC), a field programmable gate array (FPGA), and an application processor (AP), or configured with a combination of a plurality of devices such as, for example, and without limitation, the CPU, a graphics processing unit (GPU), and the like.

The processor 140 may control, based on receiving an image content through the communication device 110, the display 130 for an image corresponding to the received image content to be displayed. Specifically, the processor 140 may control the display 130 to generate image data (or video data) and audio data (or voice data) by parsing the received stream (or packet), generate an image frame (or image, frame image) by decoding each of the generated image data and audio data, and for the generated image frame to be displayed.

Then, the processor 140 may determine whether a display of a caption is necessary. Specifically, if the user has set to display the caption in the setting, or if a caption display command (or a caption service executing command) is input through an external control device (e.g., a remote controller or a smartphone), the processor 140 may determine that the display of the caption is necessary.

Then, the processor 140 may determine whether caption information is included in the received image content. Specifically, the processor 140 may check whether the caption information is included using additional information data included in the received stream data. For example, if the caption information is included in the received image content, the processor 140 may control the display 130 for the caption to be displayed using relevant caption information.

If the caption information is not included in the received image content, the processor 140 may generate text information using audio data, and generate caption information using the generated text information.

At this time, the processor 140 may proactively perform decoding of the audio data after a predetermined time than the image data which is processed by the video decoder as previously described, that is, before generating an image frame by decoding stream data corresponding to the Nth frame, extract audio data from the stream data corresponding to a predetermined time interval before the Nth frame, and generate caption information using the extracted audio data. Here, the predetermined time interval may be time corresponding to a minimum required data size necessary for audio decoding processing.

In other words, the audio data may be first proactively decoded with respect to the audio signal and the video signal corresponding to the Nth frame, and the image may be decoded thereafter.

*At this time, the caption information may include text information (i.e., text) and time information (i.e., starting time information) displayed with relevant text information. The starting time information as described may be time information at which a caption is to be displayed based on an image start point, and may be a frame number at which the relevant caption is to be displayed, a time stamp, and the like. The time information as described may be obtained using audio output time information (Presentation Time Stamp (PTS)) which is generated in a decoding process.

Then, the processor 140 may generate, when generating caption information using the text information, caption data by dividing the text included in the text information into sentence units, and generate caption data by dividing the same into word units (e.g., English), and phrase units (e.g., Korean). Meanwhile, at implementation, the caption data may be generated in sentence units, and may also be implemented in a form in which the caption frame divided into word or phrase units is generated using the caption data in sentence units in a generating process of the caption frame which will be described below.

Then, the processor 140 may generate, when the caption information is generated, a caption frame corresponding to the caption information, and control the display 130 to display by matching the sync of the generated caption frame and an image frame corresponding to the image.

Specifically, the processor 140 may store, based on the caption information being generated, the caption data in the memory 120. Then, if a display of an image with respect to the Nth frame is necessary, the processor 140 may generate a caption frame using the caption information required at a relevant time-point, generate an output image by overlaying the generated caption frame on an image frame of the Nth frame corresponding to the relevant time-point, and control the display 130 for the generated output image to be displayed. At this time, the processor 140 may prevent, based on the displayed caption frame being displayed by greater than or equal to a predetermined time, the relevant caption frame from being displayed any longer.

In addition, at implementation, the processor 140 may generate a caption frame corresponding to the relevant caption information based on the caption information, and load and display the pre-generated caption frame at a time-point at which the relevant caption frame is used.

Then, the processor 140 may perform a translating operation in the generating process of the caption information described above. For example, in case the user is a foreigner in a relevant region, or if a language of a relevant content is different from the language used by a current user, the processor 140 may generate caption information by translating a result of voice recognition expressed in a first language to a second language.

In the above, only a brief configuration of the display apparatus 100 has been described, but the display apparatus 100 may further include configurations (e.g., a speaker, an operation button, etc.) which are not shown in FIG. 2. In addition, the above-described configurations may be implemented as a set top box or an OTT player excluding the display apparatus.

Meanwhile, in describing FIG. 1 and FIG. 2, although it has been described as the caption data being generated from the audio signal, and the generated caption data being displayed as text over the image, but at implementation, the above may be displayed in a sign language form rather than the caption. For example, a sign language image corresponding to each of the words (or a sign language video, a sign language rendering image) may be displayed by being overlaid on the image.

FIG. 3 is a diagram illustrating a configuration of an electronic apparatus according to an example embodiment.

Referring to FIG. 3, an electronic apparatus 200 may process an image signal. The electronic apparatus 200 may include a signal receiving unit 205, a parsing unit 210, a decoding unit 215, a display unit 220, a user selection unit 225, a processor 230, an image data generating unit 235, a memory 240, a caption dynamic rendering area extracting unit 245, a voice data generating unit 250, an audio data caption converting unit 255, a caption data storing unit 260, and a caption synchronization controlling unit 265. The electronic apparatus 200 described above may be the display apparatus 100 as described in FIG. 2, or may be devices such as a set top box or an over the top (OTT) player which do not include the display.

The signal receiving unit 205 may receive and demodulate a broadcast signal via wire or wireless means from a broadcast company or a satellite. Further, the signal receiving unit 205 may receive image content through a network.

The parsing unit 210 may separate (or performing parsing) into image data, audio data, and additional information data from the received broadcast signal (e.g., transmitted stream signal). The parsing unit 210 may provide the separated image data and audio signal to the memory 240, and the additional information data may be provided to the processor 230.

At this time, the processor 230 may check whether caption data corresponding to the image signal is included using the additional information data. For example, the processor 230 may control, based on caption information not being included, configurations 250, 255, 260, and 265 associated with caption generation for the caption information to be generated.

Conversely, if the caption information is included, the processor 230 may control for the caption to be displayed using the caption information included in the broadcast signal. Meanwhile, at implementation, even if the caption information is included, the caption generating function may be performed with respect to the audio data. For example, if there is a partial omission in the caption information provided from the broadcast company, a caption text generated through voice recognition may be displayed in a relevant section.

Then the processor 230 may control, if the caption information is not included, the configurations 250, 255, 260, and 265 associated with caption generation for the caption information to be generated.

The decoding unit 215 may perform decoding of image data by using an image decoder. Specifically, the decoding unit 215 may perform decoding of the image data based on decoding information included in the additional information data, generate a frame image in frame units, and provide to the display unit 220.

At this time, the decoding unit 215 may include a plurality of decoders rather than one image decoder, and include not only the image decoder, but also a voice decoder. For example, if a caption display function is not activated, the audio decoding may be performed in the decoding unit 215. In addition, even if the caption display function is activated, the audio decoding may be performed, and the relevant audio data which has been decoded may be used only for the purpose of outputting audio, and not used in the caption generation.

The display unit 220 may generate a final output image using the frame image provided from the decoding unit 215. Specifically, if the caption function has not been activated, the display unit 220 may output the frame image provided from the decoding unit 215 as the output image. Further, if the caption function is activated, an output image may be generated by overlying a caption frame provided from the caption synchronization controlling unit 265 on the image frame provided from the decoding unit 215. Meanwhile, in the above, the caption frame has been described as being provided directly from the caption synchronization controlling unit 265, but at implementation, only a memory storage address at which caption frames which are to be current used are stored may be provided from the caption synchronization controlling unit 265, and it may be possible for the caption frames to be loaded and used from the relevant storage address.

The display unit described above may include a display, and if the display is included, the above-described output image may be displayed using the display. If the display unit 220 does not include the display, the above-described output image may be provided to another device. For example, the output image may be output through various image output ports or wireless streaming methods such as HDMI, DVI, and the like.

The user selection unit 225 may receive a control command from the user. For example, the above may receive not only general control commands such as a turn power on/off, a change channel, and an adjust sound volume, but also commands on whether to perform the caption display function, and the like. The user selection unit 225 as described may be configured with buttons and the like provided in the electronic device 200, or configured with devices (e.g., an IR sensor, Wi-Fi, a LAN, etc.) and the like which receive signals transmitted from the remote control device (e.g., remote controller, user smartphone, etc.).

The processor 230 may control each configuration in the electronic device 200. Specifically, when the caption function is activated, each configuration in the electronic device 200 may be controlled for decoding on an audio signal to be performed before image decoding for a specific frame is performed.

Each “processor” herein includes processing circuitry, and/or may include multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The image data generating unit 235 may receive image data from the parsing unit 210, and generate image data in frame units using the received image data and store in the memory 240.

The memory 240 may store at least one instruction necessary in operating the electronic apparatus 200. Then, the memory 240 may store various data used in the above-described operation of the electronic apparatus 200. For example, the memory 240 may store caption data provided from the caption data storing unit 260 which will be described below.

The caption dynamic rendering area extracting unit 245 may determine an area at which the caption is to be displayed. Specifically, if a caption is displayed at a key point of an image, it interferes with the appreciation of the image. In light of the above, captions are generally displayed at a lower area slightly spaced apart from the center of the image. However, if a color of the image displayed at the relevant area is the same as a color of the caption, or if the relevant area overlaps with the key point in the image, there is a need to display the captions at another area.

Accordingly, the caption dynamic rendering area extracting unit 245 may analyze the image to be displayed, and determine the area at which the caption is to be displayed. To this end, a plurality of caption areas may be predetermined, and the caption dynamic rendering area extracting unit 245 may determine the area at which the caption is to be displayed by sequentially checking whether displaying the caption at the relevant area is suitable for plurality of caption areas.

Further, the caption dynamic rendering area extracting unit 245 may determine, not only the area at which the caption is to be displayed, but also a size of the caption corresponding to the image, the color of the caption, and the like.

Then, the caption dynamic rendering area extracting unit 245 may provide information on the area at which the caption is to be displayed, information on the color and size, and the like, which is determined through the above-described process, to the display unit 220 and/or the caption data storing unit 260.

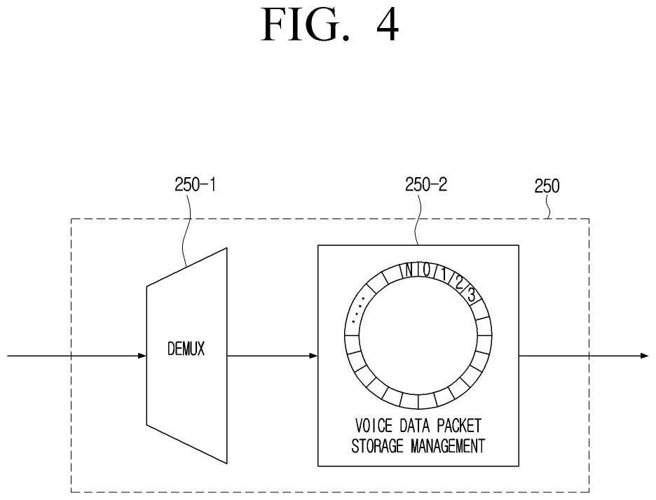

The voice data generating unit 250 may generate an audio signal from the received image signal. Specifically, only a packet included in the audio data from among the received stream data may be collected, and an audio signal may be generated using the received packet. Meanwhile, in the shown example, the audio data has been described as being generated directly from the image signal (streaming data), but at implementation, the above may be implemented in a form of using an audio signal generated by a result of parsing. Specific configurations and operations of the voice data generating unit 250 will be described below with reference to FIG. 4.

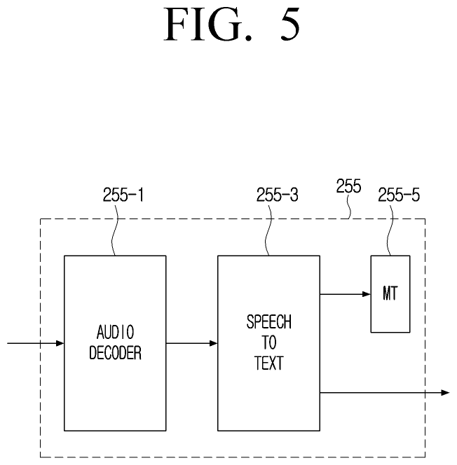

The voice data caption converting unit 255 may generate caption data using the audio data provided from the voice data generating unit 250. Specific configurations and operations of the voice data caption converting unit 255 will be described below with reference to FIG. 5.

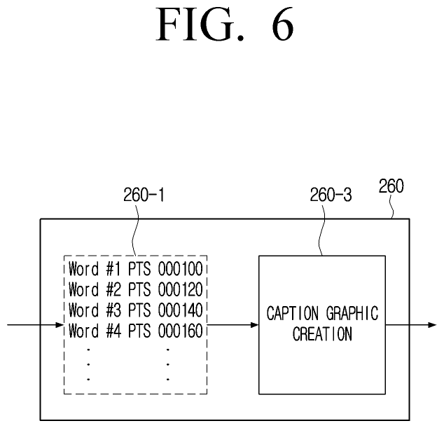

The caption data storing unit 260 may store caption data generated from the voice data caption converting unit 255 in the memory 240. Further, the caption data storing unit 260 may generate a caption frame using caption data. Specific configurations and operations of the caption data storing unit 260 will be described below with reference to FIG. 6.

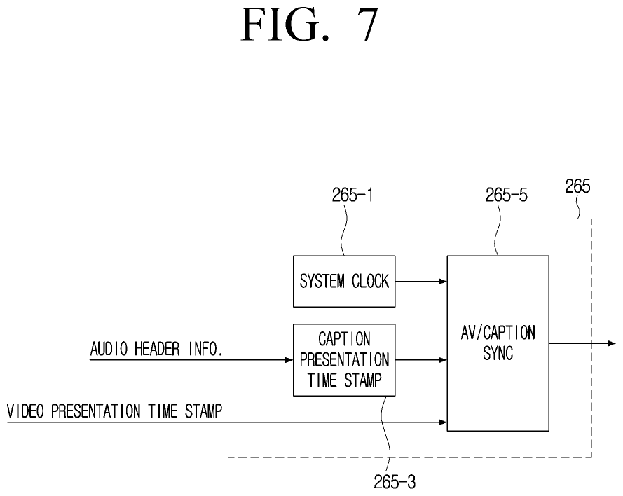

The caption synchronization controlling unit 265 may provide a corresponding caption frame to the display unit 220 based on image frame rendering information provided from the decoding unit 215. Specific configurations and operations of the caption synchronization controlling unit 265 will be described below with reference to FIG. 7.

In the above, the specific configurations of the electronic apparatus 200 have been shown and described, but at implementation, a portion of the configurations from among the above-described configurations shown may be omitted, or a portion of the configurations may be implemented as one. For example, the above-described signal receiving unit 205 and the parsing unit 210 may be implemented as a broadcast signal processing module, or the above-described voice data generating unit 250, the voice data caption converting unit 255, the caption data storing unit 260, and the caption synchronization controlling unit 265 may be implemented as one processing module. In addition, the electronic apparatus 200 may further include other configurations in addition to the shown configurations (e.g., a speaker, a communication device, etc.).

FIG. 4 is a diagram illustrating an operation of a voice data generating unit in FIG. 3.

Referring to FIG. 4, the voice data generating unit 250 may include a demux 250-1 and a packet storing module 250-2.

The demux 250-1 may load stream data (or media data) from the signal receiving unit 205, and select a packet including audio data from among the loaded media data and store in the packet storing module 250-2.

The packet storing module 250-2 may store the packet output from the demux 250-1. The packet storing module 250-2 described above may have a memory input and output method of a FIFO structure.

In this case, the demux 250-1 may check a storage space of the packet storing module 250-2, and if there is storage space, the above may select a packet including audio data and store in the packet storing module 250-2. If there is no storage space in the packet storing module 250-2, the demux 250-1 may temporarily stop an operation of loading data from the signal receiving unit 205.

Meanwhile, in FIG. 4, although the packet corresponding to the stream data has been shown and described as being directly obtained and stored, at implementation, it may also be possible to use the parsed audio data.

FIG. 5 is a diagram illustrating an operation of a voice data caption converting unit in FIG. 3.

Referring to FIG. 5, the voice data caption converting unit 255 may generate text information. Specifically, the voice data caption converting unit 255 may include an audio decoder 255-1, a voice recognition module 255-3, and a language conversion module 255-5.

The audio decoder 255-1 may perform decoding on audio data using data stored in the voice data generating unit 250. For example, the audio decoder 255-1 may check an encoding method (or a decoding method) based on header information of a packet stored in the voice data generating unit 250, and perform decoding of the audio data using the decoding method (or decoder) corresponding to the checked encoding method. To this end, the audio decoder 255-1 may store a plurality of audio decoders or a plurality of decoder libraries.

At this time, the audio decoder 255-1 may check or monitor whether data which is greater than or equal to a minimum required data size with which the audio decoding processing can be performed is stored in the voice data generating unit 250.

Further, the audio decoder 255-1 may check, when performing decoding, the audio output time information (presentation time stamp (PTS)) included in the packet used in the relevant decoding, and also obtain time information on the relevant audio data together therewith.

The voice recognition module 255-3 may perform voice recognition by using the decoded audio signal. Specifically, the voice recognition module 255-3 may include one or more language models and acoustic models, and perform voice recognition using the relevant model. Meanwhile, the module necessary in the above-described voice recognition may be manually or automatically updated.

At this time, the voice recognition module 255-3 may perform voice recognition using different algorithms for each language, sound, each auditory model in converting the decoding completed audio data into text data, and use an external DB for the use of the above-described algorithms.

Meanwhile, in the disclosure, although the electronic device 200 has been shown and described as performing voice recognition directly by storing the voice recognition model on its own, but the embodiment may be implemented in a form in which the decoded audio signal is transmitted to the external device, and caption information corresponding to the audio signal transmitted from the relevant external device is received and used.

The language conversion module 255-5 may be a translation module, and may translate text in the first language produced as a result of voice recognition to the second language which is different from the first language. For example, if an English content is played back in Korea, an operation in which a text in English is generated using audio data included in the English content, and the relevant text is translated into Korean may be performed.

Conversely, if an English-speaking foreigner views Korean content, an operation of translating a Korean text produced as the result of voice recognition to English may be performed. The language translating operation as described above is selective, and the language conversion module 255-5 may be omitted at implementation, and the above-described translating operation may be omitted even when the user does not select the language converting function

FIG. 6 is a diagram illustrating an operation of a caption data storing unit in FIG. 3.

The caption data storing unit 260 may include a caption data generating module 260-1 and a caption frame generating module 260-3.

The caption data generating module 260-1 may perform structuring of text converted data and the audio output time information of the relevant text, perform structuring of an output time of a caption graphic frame which utilized relevant words, and store the structure of text and the structure of the output time by mapping the structure s in a module memory area.

Then, the caption data generating module 260-1 may map and store, in order to obtain time information (e.g., rendering time information (caption presentation time stamp)) with respect to text which is the processing result of the voice recognition module 255-3, data bit, channel, sampling rate information utilized in the decoding process of the audio decoder 255-1 together with the processing result (i.e., text information) of the voice recognition module 255-3.

At this time, the caption data generating module 260-1 may divide and store the text which is the result of voice recognition in sentence units, and store by performing the above-described mapping process and in word units or phrase units.

The caption frame generating module 260-3 may generate a caption frame by using text information stored by the caption data generating module 260-1. Specifically, the caption frame generating module 260-3 may reflect the text data for each of the language settings stored due to structuring in generating the caption frame (or caption image frame) according to a user input setting value (X-Y coordinate/size/color) and perform generation with graphic data (vector/image) according to output properties of a system.

At this time, the caption frame generating module 260-3 may apply an algorithm reflecting linguistic readability to a maximum length sentence which can be displayed when generating a caption, and a caption graphic which is dynamically changed according to a user setting may be generated.

FIG. 7 is a diagram illustrating an operation of a caption synchronization module in FIG. 3.

Referring to FIG. 7, the caption synchronization controlling unit 265 may include a system clock module 265-1, a time information generating unit 265-3, and a sync module 265-5.

The system clock module 265-1 may provide a reference time of a device system to the sync module 265-5.

The time information generating unit 265-3 may generate caption frame rendering time information (caption presentation time stamp) from audio header information (e.g., channel, data bit, sampling rate, etc.) received from the caption data generating module 260-1.

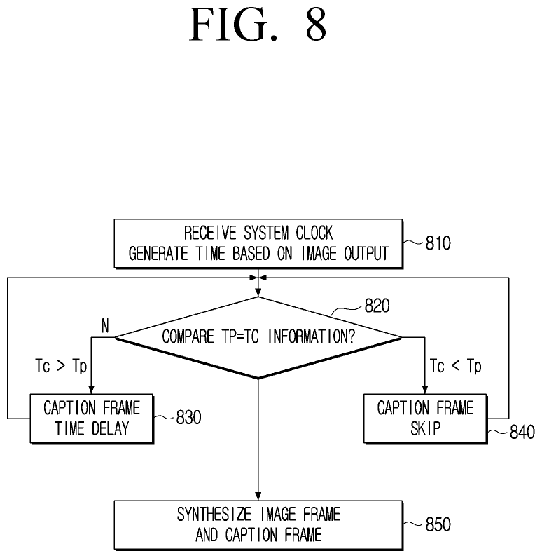

The sync module 265-5 may receive image frame rendering time information (video presentation time stamp) generated while performing the video decoding process, the reference time from the system clock module 265-1, and caption frame rendering time information from the time information generating unit 265-3, and output the caption frame (or storage location information for the relevant caption frame) corresponding to the image frame which is to be currently displayed using the above-described information. Specific operations of the sync module 265-5 will be described below with reference to FIG. 8.

*FIG. 8 is a diagram illustrating an operation of a sync module in FIG. 7.

First, in performing a media playback processing function, an increase in interval may be indicated with the modules in each diagram and a constant interval number notation information which can be referenced when performing a processing operation in the module, and the above may be converted and displayed as time information. Hereinafter, the above-described information will be denoted by ‘T’.

Referring to FIG. 8, first, the system clock may be received, and an image output reference time may be generated 810.

Then, T^{P} may compare rendering time information for each image frame generated after video decoding with rendering time information for each graphic caption frame after generating T^{c} caption (820).

Upon comparison, if the caption frame is faster than the image frame output time, the output of the relevant caption frame may be in standby until reaching the image frame output time (830), and in the opposite case, the current comparison caption frame may be skipped (840).

Then, a process of comparing the caption frame with output time information of the current image frame may be repeated and performed again and a function of display outputting both at a time at which the two frames match may be performed (850).

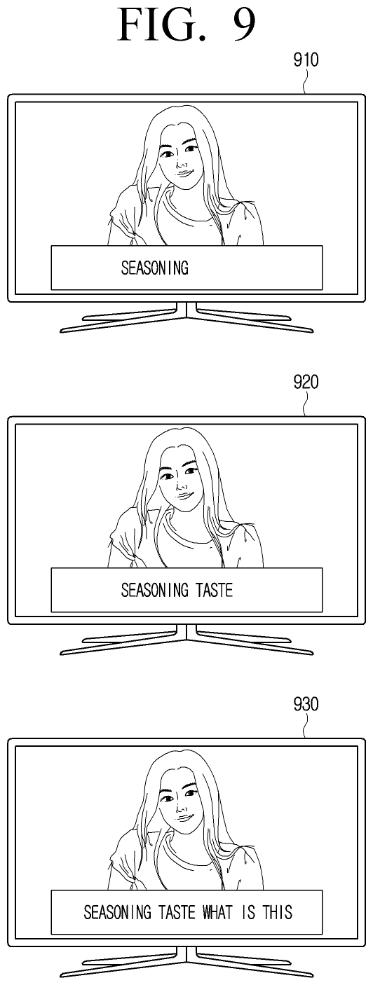

FIG. 9 is a diagram illustrating an example of displaying a caption displayed in a display apparatus.

Referring to FIG. 9, the display apparatus 100 may display the voice recognition result sequentially in phrase units. Specifically, in FIG. 1, the voice recognition result was shown as being displayed in sentence units. However, if displayed in sentence units, in light of information that has not yet been output to voice also being displayed in advance in the caption, the above may be displayed sequentially in phrase units as shown in FIG. 9.

Meanwhile, in FIG. 9, although it has been shown as displaying in phrase units, but displaying the caption information of the previous phrase together, at implementation, only the caption corresponding to the current phrase may be displayed.

Further, in the related art, display of a previous caption was maintained from when a caption is displayed until a time-point at which the next caption information is to be displayed. In this case, there were instances where a caption with no relevance with a current image was maintained. However, if a time difference between the caption and the image is greater than or equal to a certain time, as there is no need to maintain the display of the relevant caption, in the disclosure, the display of captions may be stopped after when the caption is displayed and a certain time has passed.

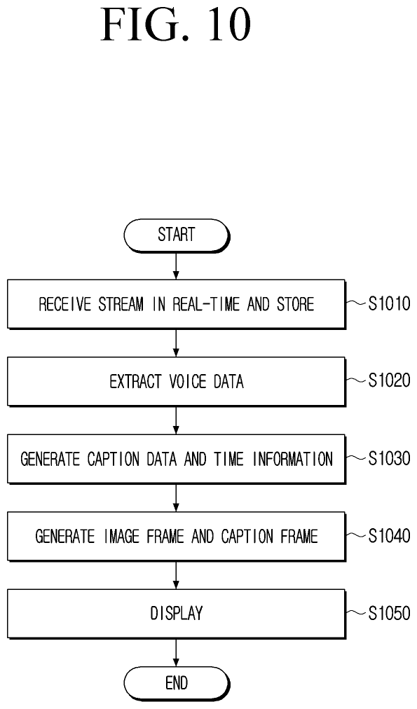

FIG. 10 is a flowchart illustrating a display method according to an example embodiment.

Referring to FIG. 10, stream data corresponding to image content may be received and stored in real-time (S1010). Meanwhile, at implementation, an operation which will be described below may be applicable for not only stream data, but also for downloaded image content.

At this time, the stream data may be stored as is, and image data and audio data may be separated from the stored stream data and stored.

Then, before generating an image frame by decoding the stream data corresponding to the Nth frame, audio data may be extracted from the stream data corresponding to the predetermined time interval before the Nth frame from among the stored stream data (S1020). Specifically, packets including audio data may be selected from the received packets and stored separately, and audio data may be extracted by decoding the stored relevant packets.

In other words, audio data may be decoded using the audio decoder, and audio data after the predetermined time than the image data processed by the video decoder may be proactively decoded.

The caption data may be generated using the extracted audio data (S1030). Specifically, text information may be generated by performing voice recognition with respect to the decoded audio data, and caption data may be generated using the generated text information. At this time, the caption data may include the text information and time information corresponding to the text information.

At this time, caption data may be generated by separating the text information into sentence, word, or phrase units. In addition, text information may be generated by translating text data in the first language generated by performing voice recognition with respect to the decoded audio data to the second language different from the first language.

The caption frame may be generated using the generated caption data (S1040). Specifically, the time information included in the caption data may include the starting time information at which the text information is to be displayed, and in this case, the caption frame including text information for a predetermined first time from a time-point corresponding to the starting time information may be generated.

The image frame may be generated by decoding the stream data corresponding to the Nth frame from among the stored stream data (S1040). If the image frame corresponding to the Nth frame is generated due to decoding being performed with respect to the Nth frame as described, because the caption information has been proactively generated due to the audio data corresponding to the Nth frame being decoded in advance, the caption frame corresponding to the Nth frame may also be in a prepared state at a current time-point.

The caption frame corresponding to the Nth frame and the image frame may be displayed together (S1050). Specifically, the output image may be generated by overlaying the caption frame on the image frame, and the generated output image may be displayed.

Because specific operations in each step has been described above, detailed descriptions thereof will be omitted.

Meanwhile, the methods according to the various embodiments of the disclosure as described above may be implemented in an application form installable in a display apparatus of the related art.

In addition, the methods according to the various embodiments of the disclosure described above may be implemented with only a software upgrade, or a hardware upgrade for the display apparatuses of the related art.

In addition, the various embodiments of the disclosure described above may be performed through an embedded server provided in the display apparatus, or an external server of at least one from among the display apparatuses.

Meanwhile, according to an example embodiment, the various embodiments described above may be implemented with software including instructions stored in a machine-readable storage media (e.g., computer). The machine may call an instruction stored in a storage medium, and as an apparatus operable according to the called instruction, may include the display apparatus according to the above-mentioned embodiments. Based on a command being executed by the processor, the processor may directly or using other elements under the control of the processor perform a function corresponding to the command. The command may include a code generated by a compiler or executed by an interpreter. A machine-readable storage medium may be provided in a form of a non-transitory storage medium. Herein, ‘non-transitory’ merely means that the storage medium is tangible and does not include a signal, and the term does not differentiate data being semi-permanently stored or being temporarily stored in the storage medium.

In addition, according to an example embodiment, a method according to the various embodiments described above may be provided included a computer program product. The computer program product may be exchanged between a seller and a purchaser as a commodity. The computer program product may be distributed in a form of the machine-readable storage medium (e.g., a compact disc read only memory (CD-ROM)), or distributed online through an application store (e.g., PLAYSTORE™). In the case of online distribution, at least a portion of the computer program product may be stored at least temporarily in the machine-readable storage medium such as a server of a manufacturer, a server of an application store, or a memory of a relay server, or temporarily generated.

In addition, according to an embodiment, the various embodiments described above may be implemented in a recordable medium which is readable by computer or an apparatus similar to computer using software, hardware, or the combination of software and hardware. In some cases, the embodiments described herein may be implemented by the processor itself. According to a software implementation, embodiments such as the procedures and functions described herein may be implemented with separate software modules. Each of the software modules may perform one or more functions and operations described herein.

Meanwhile, computer instructions for performing processing operations in a device according to the various embodiments described above may be stored in a non-transitory computer-readable medium. The computer instructions stored in this non-transitory computer-readable medium may cause a specific device to perform a processing operation of the device according to the above-described various embodiments when executed by a processor of the specific device.

The non-transitory computer-readable medium may refer to a medium that stores data semi-permanently rather than storing data for a very short time, such as a register, a cache, a memory, or the like, and is readable by a device. Specific examples of the non-transitory computer-readable medium may include, for example, and without limitation, a compact disc (CD), a digital versatile disc (DVD), a hard disc, a Blu-ray disc, a USB, a memory card, a ROM, and the like.

In addition, each of the elements (e.g., a module or a program) according to the various embodiments described above may be configured as a single entity or a plurality of entities, and a portion of sub-elements of the above-mentioned sub-elements may be omitted, or other sub-elements may be further included in the various embodiments. Alternatively or additionally, a portion of the elements (e.g., modules or programs) may be integrated into one entity to perform the same or similar functions performed by the respective elements prior to integration. Operations performed by a module, a program, or another element, in accordance with various embodiments, may be executed sequentially, in a parallel, repetitively, or in a heuristic manner, or at least a portion of the operations may be executed in a different order, omitted or a different operation may be added.

While the disclosure has been illustrated and described with reference to example embodiments thereof, it will be understood that the disclosure is intended to be illustrative, not limiting. It will be understood by those skilled in the art that various changes in form and details may be made therein without departing from the true spirit and full scope of the disclosure, including the appended claims and their equivalents. It will also be understood that any of the embodiment(s) described herein may be used in conjunction with any other embodiment(s) described herein.

1. A display apparatus, comprising:
a display;
a communication device, comprising communication circuitry, configured to receive stream data corresponding to image content in real-time;
a memory configured to store the received stream data; and
at least one processor, comprising processing circuitry, individually and/or collectively configured to:
generate an image frame at least by decoding stream data corresponding to an Nth frame from among the stored stream data, and control the display for the generated image frame to be displayed, and
extract, before generating the image frame at least by decoding stream data corresponding to the Nth frame, audio data from stream data corresponding to a predetermined time interval before the Nth frame from among the stored stream data, generate a caption frame by using the extracted audio data, and control the display to display a caption frame corresponding to the Nth frame and the image frame together.

2. The display apparatus of claim 1, wherein
the at least one processor is individually and/or collectively configured to
store by separating image data and audio data from the stored stream data, perform decoding of the audio data using an audio decoder, and perform decoding of the image data using a video decoder, and
wherein the audio decoder is configured to proactively perform decoding of audio data after a predetermined time than the image data which is processed by the video decoder.

3. The display apparatus of claim 2, wherein
the at least one processor is individually and/or collectively configured to
perform decoding of audio data corresponding to the predetermined time interval from among the stored audio data, generate text information by performing voice recognition with respect to the decoded audio data, and generate caption data using the generated text information.

4. The display apparatus of claim 3, wherein
the at least one processor is individually and/or collectively configured to
generate the caption data at least by separating the text information into sentence, word, and/or phrase units.

5. The display apparatus of claim 3, wherein
the at least one processor is individually and/or collectively configured to
generate text information at least by translating text data of a first language generated at least by performing voice recognition with respect to the decoded audio data into a second language different from the first language.

6. The display apparatus of claim 3, wherein
the at least one processor is individually and/or collectively configured to
generate caption data comprising the text information and time information corresponding to the text information.

7. The display apparatus of claim 6, wherein
the time information comprises starting time information at which the text information is to be displayed, and
the at least one processor is individually and/or collectively configured to generate a caption frame comprising the text information for a predetermined first time from a time-point corresponding to the starting time information.

8. A display method in a display apparatus, the method comprising:
receiving and storing stream data corresponding to image content in real-time;
extracting, before generating an image frame at least by decoding stream data corresponding to an Nth frame, audio data from stream data corresponding to a predetermined time interval before the Nth frame from among the stored stream data;
generating a caption frame using the extracted audio data;
generating an image frame at least by decoding stream data corresponding to the Nth frame from among the stored stream data; and
displaying a caption frame corresponding to the Nth frame and the image frame together.

9. The display method of claim 8, further comprising:
storing by separating image data and audio data from the stored stream data; and
decoding the audio data using an audio decoder,
wherein the generating an image frame comprises
decoding the image data using a video decoder, and
wherein the audio decoder proactively performs decoding of audio data after a predetermined time than the image data which is processed by the video decoder.

10. The display method of claim 9, wherein
the generating a caption frame comprises
generating text information at least by performing voice recognition with respect to the decoded audio data; and
generating caption data at least by using the generated text information.

11. The display method of claim 10, wherein
the generating caption data comprises
generating the caption data by separating the text information into sentence, word, and/or phrase units.

12. The display method of claim 10, wherein
the generating text information comprises
generating text information at least by translating text data of a first language generated at least by performing voice recognition with respect to the decoded audio data into a second language different from the first language.

13. The display method of claim 10, wherein
the generating caption data comprises
generating caption data comprising the text information and time information corresponding to the text information.

14. The display method of claim 13, wherein
the time information comprises starting time information at which the text information is to be displayed, and
the generating a caption frame comprises
generating a caption frame comprising the text information for a predetermined first time from a time-point corresponding to the starting time information.

15. A non-transitory computer-readable recording medium, comprising a program for executing a display method comprising:
receiving and storing stream data corresponding to image content in real-time;
extracting, before generating an image frame at least by decoding stream data corresponding to an Nth frame, audio data from stream data corresponding to a predetermined time interval before the Nth frame from among the stored stream data;
generating a caption frame using the extracted audio data;
generating an image frame at least by decoding stream data corresponding to the Nth frame from among the stored stream data; and
generating an output image by overlaying a caption frame corresponding to the Nth frame on an image frame corresponding to the Nth frame.
